(19) United States
(12) Patent Application Publication
(10) Pub. No.: US 2006/0291092 A1
(43) Pub. Date: Dec. 28, 2006

(54) Recording and/or reproducing device having a clutch member with a controllable play

(75) Inventors: Nobutaka Tsuneyoshi, Kanagawa (JP); Hiromi Inoguchi, Kanagawa (JP); Kouji Kobayashi, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 11/407,302

(22) Filed: Apr. 19, 2006

(30) Foreign Application Priority Data
Jun. 28, 2005 (JP) 2005-187715

(51) Int. Cl. G11B 15/00

(52) U.S. Cl. 360/96.5

(57) ABSTRACT

A clutch member coupling a first gear with a second gear with a play has a first clutch gear engaged with the first gear and a second clutch gear engaged with the second gear. Between the first clutch gear and the second clutch gear, a torsion spring for imparting the play to the clutch member is disposed. A combination of a protrusion portion, a lock arm cam, and a lock arm controls so that the play caused by the torsion spring is effective while a rotational angle of the first clutch gear lies in a first angular range and controls so that the play caused by the torsion spring is ineffective so as to make the first clutch gear and the second clutch gear move integrally while the rotational angle of the first clutch gear lies in a second angular range.

This application claims priority to Japanese Patent Application JP 2005-187715, the disclosure of which is incorporated herein by reference.

### BACKGROUND OF THE INVENTION

This invention relates to a recording and/or reproducing device represented by DLT (digital linear tape) or LTO (linear tape open) and, in particular, to a clutch member included in a transmission mechanism for transmitting driving force of a driving motor to a cam slider.

Recording and/or reproducing devices of the type described are developed for use in back-up ones of computer systems and various types of the recording and/or reproducing devices have been proposed in prior art. Such a recording and/or reproducing device serving as the LTO is disclosed, for example, in U.S. Pat. No. 6,322,014 issued to Robert Nemeth that will later be called a patent document 1.

The recording and/or reproducing device may be also a tape drive in which a cartridge having a single reel (a supply reel) can be installed. The cartridge may be also called a cassette. The recording and/or reproducing device contains a take-up reel therein. When the cartridge is installed in the recording and/or reproducing device, a magnetic tape is pulled out of the cartridge and then is wound by the take-up reel through a tape-transport path. The tape-transport path is for guiding the magnetic tape pulled out of the cartridge in a magnetic head. The magnetic head exchanges information between the tape and the magnetic head. In addition, the take-up reel is rotationally drivable by means of a real motor.

For holding the cartridge, the tape drive has holder means which is referred to as a lift. The lift is also called a cartridge holder. The lift is movable between a loading position and an operating position. The lift is moved along an L-shaped path of movement. That is, the lift first be moved from its loading position into its operating position in the direction of insertion (a horizontal direction) and, subsequently, in a direction (a vertical direction) towards a chassis perpendicularly to the direction of insertion.

In order to obtain this direction of movement, the tape drive has guide means including a first guide wall and a second guide wall. The two guide walls have guide channel slots or guide channels, which are engaged by guide pins which project laterally from the lift.

The tape drive has actuating means for moving the lift (the cartridge holder). The actuating means includes two actuating slides which are guided so as to be slidable parallel to the direction of insertion (the horizontal direction). The two actuating slides are each connected to a gear rack. Each of the actuating slides has a cam surface which are inclined with respect to the plane of the chassis, which each cooperates with a cam follower which projects laterally from the lift. As a result, the lift is movable by moving the actuating slides. The actuating means is also called a cam slider.

At any rate, the actuating means (the cam slider) is for making the lift (the cartridge holder) move in the horizontal direction and the vertical direction.

The tape drive comprises a driving motor and a transmission mechanism, which is disposed between the driving motor and the actuating means (the cam slider), for transmitting driving force of the driving motor to the actuating means (the cam slider).

A conventional tape drive is provided with a tensile spring or a torsion spring between the cam slider and the transmission mechanism to impart a play due to deformation of the spring. Therefore, the conventional tape drive adopts structure (an auto-loading mechanism) where a start switch is turned on by pressing in the cartridge a small amount. In addition, the conventional tape drive has a load distributed structure so that the spring deforms without directly loading the transmission mechanism although any foreign substance is set in a cartridge insertion opening.

In addition, as the structure for imparting the play, in prior art, a clutch member is provided in the transmission mechanism, as disclosed in Japanese Unexamined Utility Model Application Publication Jikkai No. Hei 6 (1994)-30932 or JP-U 6-30932, which will later be called a patent document 2. The patent document 2 discloses a cassette holder open/close apparatus for opening/closing a cassette holder by engaging rotational driving force of a motor with a transmission reduction mechanism due to a plurality of gears and a gear concentric with an open/close pivot of the cassette holder. In the transmission reduction mechanism, a friction mechanism is provided which comprises a worm gear, intermediate gear, a clutch plate, and a clutch spring. With transmitting the driving force for open/close, the friction mechanism carries out absorption of excess torque by idle running between the clutch plate and the worm gear or the intermediate gear at open/close ends. In addition, if the cassette holder is manually abruptly closed, it is possible to prevent the gears from breaking by idle running the intermediate gear and the clutch plate in the friction mechanism. With the friction mechanism (the clutch plate) such a structure, the play is always imparted (set).

In addition, a motor clutch for car logic deck is disclosed in Japanese Unexamined Patent Publication Tokkai No. 2001-165203 or JP 2001-165203 A, which will later called patent document 3. Disclosed the patent document 3, the motor clutch for car logic deck securely carries out rotational operation of a motor pulley for a tape transfer by a clutch operation of a stopper caused by centrifugal force of a driving motor in a rotational direction. In the patent document 3, a motor gear and the motor pulley are sequentially rotatably provided on a pulley shaft which is horizontally arranged in the driving motor. The stopper is provided in a level difference portion of the motor gear installed on the pulley shaft. The motor pulley conveying a tape by connected to a belt is formed with a recess in it rear circumferential face and a lock projection projected in the recess. The stopper is hung on the lock projection of the motor pulley to actuate the above-mentioned pulley by the centrifugal force of the motor in the opposite direction to a clockwise direction of the driving motor.

However, the above-mentioned play structure is a structure required for only near the cartridge insertion opening such that the cartridge holder is moved in the horizontal direction. For instance, at a position (duration) where the load becomes large on seating/unseating of the cartridge or the like such that the cartridge holder is moved in the vertical direction, it is necessary to integrally operate the transmission mechanism and the cam slider. This is because operation of the cartridge becomes discontinuous in a case where the play of the clutch member is effective at this position (duration). In addition, in a case of repeatedly carrying out a loading operation and an ejection operation of the cartridge, a shock or an impact is given to the transmission mechanism and it results in impairing reliability of the tape drive.

Such a problem cannot avoid in a case of using the clutch member (the friction mechanism) having always the play, as disclosed in the above-mentioned patent document 2. In addition, it is difficult to resolve the above-mentioned problem in the clutch using the centrifugal force of the driving motor in the rotational direction, as disclosed in the above-mentioned patent document 3.

### SUMMARY OF THE INVENTION

It is therefore an object of the present invention to provide a recording and/or reproducing device provided with a clutch member which is capable of controlling effectiveness and ineffectiveness of a play according to a rotational position.

Other objects of this invention will become clear as the description proceeds.

On describing the gist of a first aspect of this invention, it is possible to be understood that a recording and/or reproducing device comprises a cartridge holder for holding a cartridge, a cam slider for moving the cartridge in a horizontal direction and a vertical direction, a driving motor, a transmission mechanism, disposed between the driving motor and a cam slider, for transmitting driving force of the driving motor to the cam slider. According to the first aspect of this invention, the transmission mechanism includes a clutch member where a play is effective in a first angular range and the play is ineffective in a second angular range.

In the above-mentioned recording and/or reproducing device, the first angular range may corresponds to a range where the cam slider makes the cartridge holder move in the horizontal direction, the second angular range corresponds to another range where the cam slider makes the cartridge holder move in the vertical direction. The transmission mechanism may include a first reduction gear for transmitting the driving force of the driving motor to the clutch member and a second reduction gear for transmitting transmission force of the clutch member to the cam slider. In this event, the clutch member couples the first reduction gear with the second reduction gear with the play.

In the above-mentioned recording and/or reproducing device, the clutch member may comprise a rotation axis, a first clutch member, rotatably disposed around the rotation axis, for being engaged with the first reduction gear, a second clutch member, rotatably disposed around the rotation axis, for being engaged with the second reduction gear, a play imparting arrangement, disposed between the first clutch member and the second clutch member, for imparting the play to the clutch member, and a play controlling arrangement for controlling so that the play caused by the play imparting arrangement is effective while a rotational angle of the first clutch gear lies in the first angular range and for controlling so that the play caused by the play imparting arrangement is ineffective so as to make the first clutch gear and the second clutch gear move integrally while the rotational angle of the first clutch gear lies in the second angular range. The play imparting arrangement may comprises a torsion spring. The play controlling arrangement may comprise a protrusion portion for projecting from the second clutch gear toward the first clutch gear, a lock arm, rotatably mounted on the first clutch gear around a pivot thereof, having a hook portion enable to engage with the protrusion portion, and a lock arm controlling arrangement for controlling so as to disengage the hook portion of the lock arm from the protrusion portion while the rotational angle of the first clutch gear lies in the first angular range and for controlling so as to engage the hook portion of the lock arm with the protrusion portion while the rotational angle of the first clutch gear lies in the second angular range.

In the above-mentioned recording and/or reproducing device, the lock arm may comprise a cam follower at an end opposite to the hook portion. The cam follower is freely inserted through an opening of the first clutch gear. In this event, the lock arm controlling arrangement may comprise a lock arm cam, fixed to a fixing member, having a cam groove with which the cam follower is engaged. Alternatively, the lock arm controlling arrangement may comprise a lock arm cam, fixed to a fixing member, having a cam surface, and an urging arrangement for urging the cam follower to press the cam follower against the cam surface so as to make the lock arm be slidably in contact with the cam surface. The urging arrangement may comprise a torsion spring mounted around the pivot.

On describing the gist of a second aspect of this invention, it is possible to be understood that a clutch member couples a first gear with a second gear with a play. According to the second aspect of this invention, the clutch member comprises a rotation axis, a first clutch member, rotatably disposed around the rotation axis, for being engaged with the first gear, a second clutch member, rotatably disposed around the rotation axis, for being engaged with the second gear, a play imparting arrangement, disposed between the first clutch member and the second clutch member, for imparting the play to the clutch member, and a play controlling arrangement for controlling so that the play caused by the play imparting arrangement is effective while a rotational angle of the first clutch gear lies in a first angular range and for controlling so that the play caused by the play imparting arrangement is ineffective so as to make the first clutch gear and the second clutch gear move integrally while the rotational angle of the first clutch gear lies in a second angular range.

In the afore-mentioned clutch member, the play imparting arrangement may comprise a torsion spring. The play controlling arrangement may comprise a protrusion portion for projecting from the second clutch gear toward the first clutch gear, a lock arm, rotatably mounted on the first clutch gear around a pivot thereof, having a hook portion enable to engage with the projection portion, and a lock arm controlling arrangement for controlling so as to disengage the hook portion of the lock arm from the protrusion portion while the rotational angle of the first clutch gear lies in the first angular range and for controlling so as to engage the hook portion of the lock arm with the protrusion portion while the rotational angle of the first clutch gear lies in the second angular range.

In the afore-mentioned clutch member, the lock arm may comprise a cam follower at an end opposite to the hook portion. The cam follower is freely inserted through an opening of the first clutch gear. In this event, the lock arm controlling arrangement may comprise a lock arm cam, fixed to a fixing member, having a cam groove with which the cam follower is engaged. Alternatively, the lock arm controlling arrangement may comprise a lock arm cam, fixed to a fixing member, having a cam surface, and an urging arrangement for urging the cam follower to press the cam follower against the cam face so as to make the lock arm be slidably in contact with the cam surface. The urging arrangement may comprise a torsion spring mounted around said pivot.

### BRIEF DESCRIPTION OF THE DRAWINGS

FIG. 1 is a perspective view showing a tape drive serving as a recording and/or reproducing device to which this invention is applicable with an upper cover removed therefrom seen from an upper surface thereof;

FIG. 2 is an exploded perspective view of a clutch member according to a first embodiment of this invention that is used in the tape drive illustrated in FIG. 1;

FIG. 3 is a perspective view of an upper clutch gear for use in the clutch member illustrated in FIG. 2 seen from a lower surface thereof;

FIG. 4 is an enlarged plan view for use in describing a state of the clutch member when a cartridge lies near a cartridge insertion opening as the tape drive illustrated in FIG. 1;

FIG. 5 is a perspective view showing the tape drive in a state where the cartridge is inserted in a horizontal direction (an insertion direction) as far as it;

FIG. 6 is an enlarged plan view for use in describing anther state of the clutch member when the tape drive is put into the state illustrated in FIG. 5;

FIG. 7 is a perspective view showing the tape drive in a state where the cartridge is moved in a vertical direction;

FIG. 8 is an enlarged plan view for use in describing a still another state of the clutch member when the tape drive is put into the state illustrated in FIG. 7; and

FIG. 9 is an enlarged plan view for use in describing structure of a clutch member according to a second embodiment of this invention.

### DESCRIPTION OF THE PREFERRED EMBODIMENTS

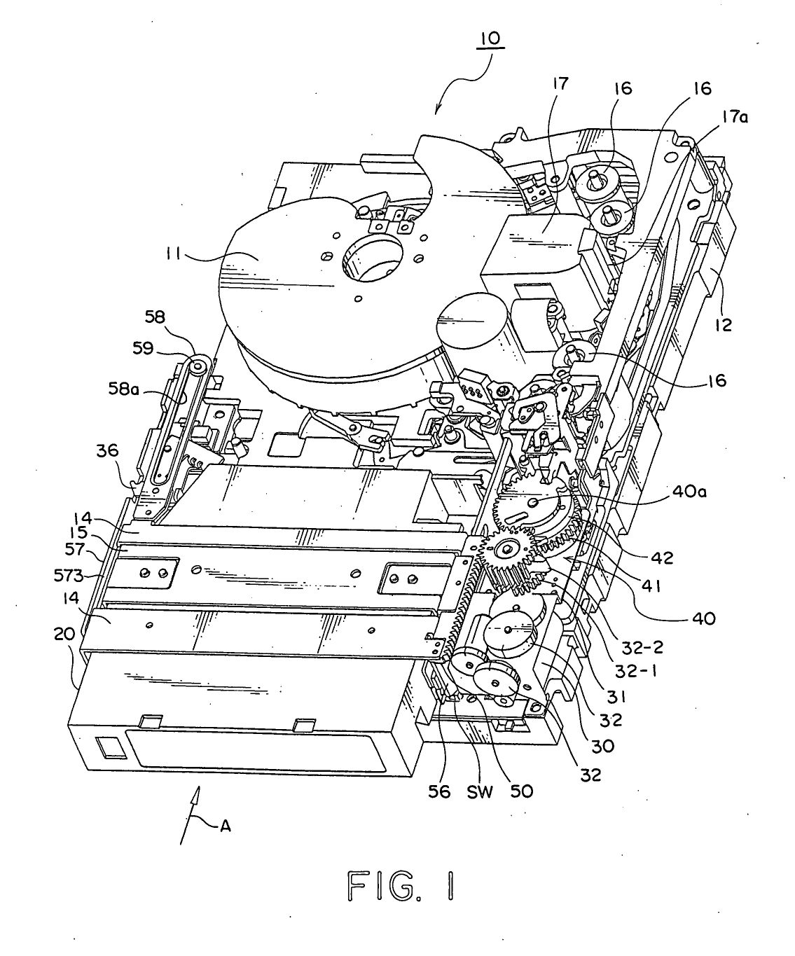

Referring to FIG. 1, the description will first proceed to a tape drive 10 serving as a recording and/or reproducing device to which this invention is applicable. In addition, FIG. 1 is a perspective view showing the tape drive 10 with an upper cover removed therefrom seen from an upper surface side.

The tape drive 10 is for receiving a cartridge 20 and contains a take-up reel 11 inside thereof. The take-up reel 11 is also called a spool. The tape drive 10 is generally comprised of a rectangular housing (chassis) 12 that has a common base. The base has a first spindle motor (reel motor) (not shown) and a second spindle motor (reel motor). The first spindle motor has the spool (or the take-up reel) 11 permanently mounted on the base of the housing 12 and the spool 11 is dimensioned to accept a relatively high speed streaming magnetic tape (not shown). The second spindle motor (reel motor) is adapted to accept the removable cartridge 20. The removable cartridge 20 is inserted into the tape drive 10 via a cam slider 14 formed on the housing 12 of the tape drive 10 along an insertion direction depicted at an arrow A.

Upon insertion of the cartridge 20 into the cam slider 14, the cartridge 20 first is engaged in a cartridge holder 15, is automatically loaded in the tape drive 10, and then the cartridge 20 engages with the second spindle motor (the supply reel motor) 13 in the manner which will later be described. Prior to rotation of the first and the second spindle motors (reel motors), the cartridge 20 is connected to the permanently mounted spool (the take-up reel) 11 by means of a connection between a grabber (not shown) and a leader pin (not shown). A number of rollers (guide rollers) 16 positioned intermediate the cartridge 20 and the permanent spool 11 guide the magnetic tape as it traverses at relatively high speeds back and forth between the cartridge 20 and the permanently mounted spool 11.

The tape drive 10 further comprises a head actuator assembly 17 having a magnetic head 17a. The head actuator 17 is located between the take-up spool 11 and the cartridge 20 on a tape-transport path (not shown) defined by the above-mentioned plurality of rollers 16. During operation, the magnetic tape flows forward and backward between the take-up spool 11 and the cartridge 20 and is closely adjacent to the magnetic head 17a of the head actuator 17 while the magnetic tape flows on the defined tape-transport path.

The tape drive 10 has a switch SW provided on a main surface of the chassis 12 at a front and right-hand side thereof. The switch SW is for detecting a position at which an automatic loading starts after the cartridge 20 is inserted in the cam slider 14. The switch SW is called a start switch. The switch SW comprises a photo-interrupter. The cam slider 14 comprises a shielding plate (not shown) for shielding the switch SW.

The tape drive 10 comprises a mode motor (a driving motor) 30 mounted on the main surface of the chassis 12. In the example being illustrated, the mode motor (the driving motor) 30 is installed forward of the chassis 12 at right-hand side thereof. The mode motor (the driving motor) 30 is covered by a motor bracket 31 fixed on the chassis 12. On the motor bracket 31, a plurality of reduction gears 32 is mounted. Those reduction gears 32 are rotated by driving force of the mode motor (the driving motor) 30. Among the plurality of reduction gears 32, two reduction gears 32-1 and 32-2 are rotatably mounted on the motor bracket 31 around the same rotation axis thereof. Hereinafter, the reduction gear 32-1 is called a first reduction gear while the reduction gear 32-2 is called a second reduction gear.

In addition, on the motor bracket (a fixing member) 31, a clutch member 40 according to this invention is mounted. The clutch member 40 comprises first and second clutch gears 41 and 42 which are rotatably provided around the same rotation axis 40a thereof. The first clutch gear 41 is called a lower clutch gear because it is disposed at lower side. The second clutch gear 42 is called an upper clutch gear because it is disposed at upper side. The first clutch gear 41 engages with the first reduction gear 32-1 while the second clutch gear 42 engages with the second reduction gear 32-2. In addition, the second reduction gear 32-2 is engaged with a gear rack 50 which fixedly mounted to a right-hand wall of the cam slider 14.

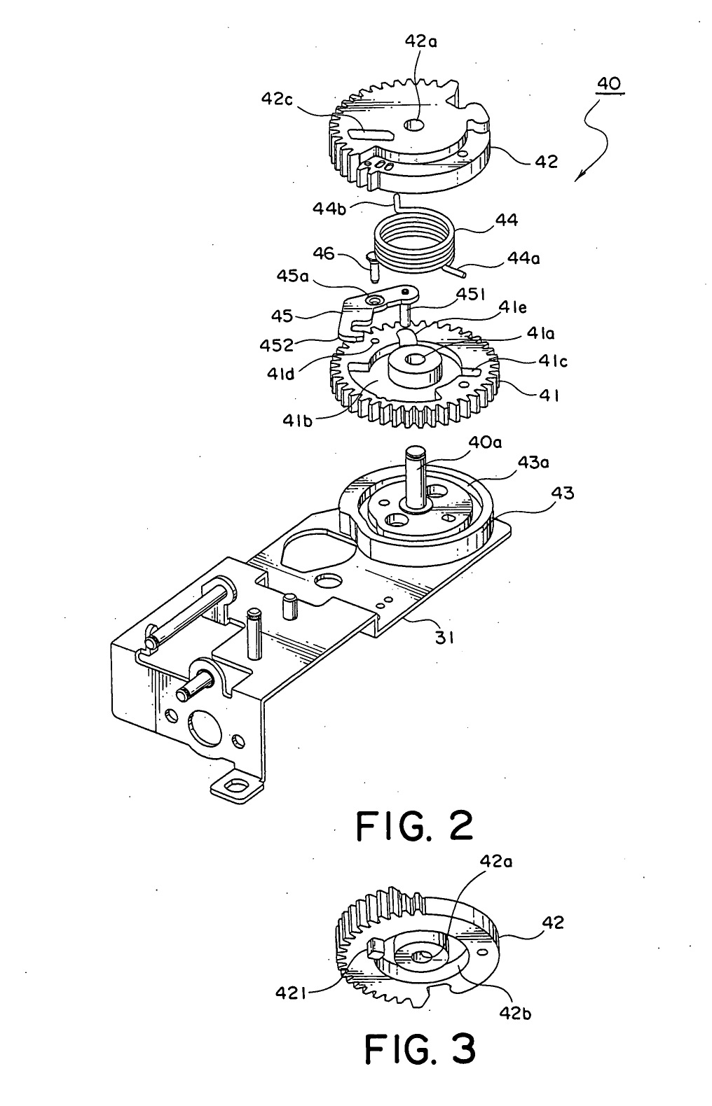

That is, the first reduction gear 32-1 is for transmitting driving force of the driving motor 30 to the clutch member 40. In addition, the second reduction gear 32-2 is for transmitting transmission force of the clutch member 40 to the cam slider 14. At any rate, a combination of the reduction gears 32, the clutch member 40, and the gear rack 50 serves as a transmission mechanism for transmitting the driving force of the mode motor (the driving motor) 30 to the cam slider 14. In addition, structure of the clutch member 40 will later be described in conjunction with FIGS. 2 and 3.

Referring now to FIG. 1, the description will proceed to a guide arrangement for guiding the cam slider 14 and the cartridge holder 15.

The tape drive 10 comprises, as the guide arrangement, a first guide wall 56 and a second guide wall 57 both of which extend in the insertion direction A. The first guide wall 56 is called a right-hand guide wall because it is disposed in a right hand with respect to the insertion direction A. The second guide wall 57 is called a left-hand guide wall because it is disposed in a left hand with respect to the insertion direction A.

The first guide wall (the right-hand guide wall) 56 has a first guide channel slot (not shown) for guiding the cam slider 14 and a second guide channel slot (not shown) for guiding the cartridge holder 15. The first guide channel slot extends along the insertion direction A. On the other hand, the second guide channel slot has an L-shape which extends along the insertion direction A and extends in a direction perpendicular to the insertion direction A toward the chassis 12. In the first guide channel slot, a first guide pin (not shown) is engaged. The first guide pin projects laterally from a right-hand wall of the cam slider 14. In the second guide channel slot, a second guide pin (not shown) is engaged. The second guide pin projects laterally from a right-hand wall of the cartridge holder 15.

The second guide wall (the left-hand guide wall) 57 has a pair of third guide channel slots 573 for guiding the cam slider 14 and a pair of fourth guide channel slots (not shown) for guiding the cartridge holder 15. The pair of third guide channel slots 573 extends along the insertion direction A. On the other hand, the pair of fourth guide channel slots has an L-shape which extends along the insertion direction A and extends in a direction perpendicular to the insertion direction A toward the chassis 12. In the pair of third guide channel slots 573, a pair of third guide pins (not shown) is engaged, respectively. The pair of third guide pins projects laterally from a left-hand wall of the cam slider 14. In the pair of fourth guide channel slots, a pair of fourth guide pins (not shown) is engaged, respectively. The pair of fourth guide pins projects laterally from a left-hand wall of the cartridge holder 15.

In addition, the cam slider 14 has a left-hand front end portion on which a guide member 58 is mounted. The guide member 58 extends forward along the insertion direction A. The guide member 58 has a guide long hole 58a formed therein. The guide long hole 58a extends in the insertion direction A. In the guide long hole 58a, a guide roller 59 is inserted. The guide roller 59 is rotatably mounted on a front end portion of the second guide wall (the left-hand guide wall) 57. Accordingly, the guide member 58 is slidably mounted to the cam slider 14 in the insertion direction A.

As shown in FIG. 1, the tape drive 10 comprises a cartridge holder locking mechanism 36 for locking the cartridge holder 15 (the cam slider 14). The cartridge holder locking mechanism 36 is for preventing the cam slider 14 from moving in the insertion direction A when the cartridge 20 is not correctly inserted in the cartridge holder 15 (the cam slider 14). Accordingly, when the cartridge 20 is correctly inserted in the cartridge holder 15, a lock of the cartridge holder 15 (the cam slider 14) by the cartridge holder locking mechanism 36 is released and it results in allowing the cartridge holder 15 (the cam slider 14) to move in the insertion direction A.

In the manner which is described above, the cam slider 14, which makes the cartridge holder 15 holding the cartridge 20 move, is coupled to the mode motor (the driving motor) 30 via the above-mentioned transmission mechanism.

When the cartridge 20 is perfectly inserted in the cam slider 14, the cartridge 20 is held in the cartridge holder 15. In addition, the cam slider 14 is only movable along the insertion direction A by the above-mentioned guide arrangement. The cartridge holder 15 is movable along the L-shaped pass of movement by the guide arrangement.

With this structure, when the cartridge 20 is manually inserted in the cam slider 14, the lock of the cartridge holder 15 (the cam slider 14) by the cartridge holder locking mechanism 36 is released and the cam slider 14 moves in the insertion direction A. Inasmuch as the gear rack 50 is fixedly mounted on the right-hand wall of the cam slider 14, the second reduction gear 32-2 engaged with the gear rack 50 rotates around the rotation axis thereof clockwise. Therefore, the upper clutch gear 42 of the clutch member 40 rotates around the rotation axis 40a counterclockwise. However, inasmuch as the clutch member 40 has a play in the manner which will later be described, the lower clutch gear 41 does not rotate. This operation is a manual load operation. However, in a case where the tape drive 10 is mounted in an autoloader/library system, it is noted that an insertion of the cartridge 20 in the cam slider 14 is automatically carried out by the autoloader/library system.

On the other hand, the cam slider 14 and the mode motor (the driving motor) 30 are coupled to each other via the above-mentioned transmission mechanism. Accordingly, if the mode motor (the driving motor) 30 rotates in a predetermined direction, the cam slider 14 moves in the insertion direction A via the transmission mechanism. In this event, engaged with (held in) the cartridge holder 15, the cartridge 20 also moves in the insertion direction A. This operation is an automatic load operation.

A switching between the manual load operation and the automatic load operation is carried out by turning on/off of the above-mentioned start switch SW.

Referring now to FIG. 1, the description will be briefly made about an operation in a case of loading the cartridge 20.

In the manner which is described above, the cartridge holder 15 (the cam slider 14) is locked (or fixed) by the cartridge holder locking mechanism 36 until the cartridge 20 is inserted therein.

In this state, it will be assumed that the cartridge 20 is manually inserted in the cam slider 14 along the insertion direction A. Thereby, the above-mentioned lock of the cartridge holder 15 (the cam slider 14) by the cartridge holder locking mechanism 36 is released and the cam slider 14 is movable along the insertion direction A. In this event, the cartridge holder locking mechanism 36 rotates around the rotation axis thereof in a clockwise direction.

When the cartridge 20 is perfectly inserted in the cam slider 14, the cartridge 20 is held in the cartridge holder 15.

In this state, it will be assumed that the cartridge 20 is further manually pushed in the insertion direction A. Thereby, the cam slider 14 is pushed in the insertion direction A. As a result, engaged with the gear rack 50 fixed to the cam slider 14, the second reduction gear 32-2 rotates around the rotation axis thereof in the clockwise direction. Thereby, engaged with the second reduction gear 32-2, the upper clutch gear 42 of the clutch member 40 rotates around the rotation axis 40a thereof in the counterclockwise direction. Inasmuch as the clutch member 40 has the play in the manner which is described above, the lower clutch gear 41 does not rotate even if the upper clutch gear 42 rotates.

When the cartridge 20 is furthermore manually pushed in the insertion direction A by a small amount, the above-mentioned start switch SW is turned on at a predetermined position and an automatic load switching signal is sent to a control circuit (not shown). Responsive to the automatic load switching signal, the control circuit drives the mode motor (the driving motor) 30 to rotatably drive the first reduction gear 32-1 around the rotation axis thereof in the clockwise direction. Thereby, engaged with the first reduction gear 32-1, the lower clutch gear 41 of the clutch member 40 rotates around the rotation axis 40a thereof in the counterclockwise direction. Thereby, the upper clutch gear 42 also rotates around the rotation axis 40a thereof in the counterclockwise direction with the play of the clutch member 40. Engaged with the upper clutch gear 42, the second reduction gear 32-2 rotates around the rotation axis thereof in the clockwise direction. Therefore, inasmuch as the gear rack 50 engaged with the second reduction gear 32-2 moves along the insertion direction A, the cam slider 14 also moves along the insertion direction A. As a result, held in the cartridge holder 15, the cartridge 20 also moves along the insertion direction A. In the manner which is described above, the automatic load operation of the cartridge 20 is carried out.

Referring now to FIGS. 2 and 3, the description will be made as regards structure of the clutch member 40 provided on the motor bracket 31 in detail. FIG. 2 is an exploded perspective view of the clutch member 40. FIG. 3 is a perspective view of the upper clutch gear 42 seen from a lower surface thereof.

The clutch member 40 comprises the above-mentioned lower clutch gear 41, the above-mentioned upper clutch gear 42, and a lock arm cam 43 on which the rotation axis 40a stands. The lock arm cam 43 is fixed on the motor bracket 31. The lower clutch gear 41 is rotatably mounted on the lock arm cam 43 around the rotation axis 40a. The upper clutch gear 42 is rotatably mounted on the lower clutch gear 41 around the rotation axis 40a. The lower clutch gear 41 has an axial hole 41a in which the rotation axis 40a is inserted while the upper clutch gear 42 has an axial hole 42a in which the rotation axis 40a is inserted.

Between the lower clutch gear 41 and the upper clutch gear 42, a torsion spring 44 is disposed. More specifically, the lower clutch gear 41 has a substantially ring-shaped concave portion 41b in which the torsion spring 44 is received. As shown in FIG. 3, the upper clutch gear 42 also has a ring-shaped concave portion 42b in which the torsion spring 44 is received. In addition, the lower clutch gear 41 has an engaging groove 41c for engaging with an end (one leg) 44a of the torsion spring 44. The upper clutch gear 42 has an engaging groove 42c for engaging with another end (another leg) 44b of the torsion spring 44. By the torsion spring 44, the play is imparted to the clutch member 40. That is, the torsion spring 44 serves as a play imparting arrangement for imparting the play to the clutch member 40.

On the lower clutch gear 41, a lock arm 45 is rotatably mounted. More specifically, the lower clutch gear 41 has a through hole 41d and the lock arm 45 has an axial hole 45a at a position corresponding to the through hole 41d. Through the axial hole 45a and the through hole 41d, a lock arm pivot 46 is inserted. Accordingly, the lock arm 45 is rotatably mounted on the lower clutch gear 41 around the lock arm pivot 46.

In addition, the lock arm 45 has a protrusion portion (a cam follower) 451 at an end thereof. The protrusion portion 451 projects downward. The lower clutch gear 41 has an opening 41e through which the cam follower 451 is freely inserted or fitted. The lock arm cam 43 has a cam groove 43a with which the cam follower 451 is engaged. That is, the cam follower 451 of the lock arm 45 is engaged with the cam groove 43a through the opening 41e of the lower clutch gear 41.

Furthermore, the lock arm 45 has a hook portion 452 at another end thereof. As shown in FIG. 3, the upper clutch gear 42 has a protrusion portion 421 which is enable to engage with the hook portion 452. That is, the clutch member 40 has structure where the lock arm 45 moves along the cam groove 43a of the lock arm cam 43 when the lower clutch gear 41 rotates and the hook portion 452 of the lock arm 45 is engaged or disengaged with or from the protrusion portion 421 of the upper clutch gear 42 at a predetermined rotational position of the lower clutch gear 41.

When the hook portion 452 of the lock arm 45 is disengaged from the protrusion portion 421 of the upper clutch gear 42, the play caused by the torsion spring 44 is set in (imparted to) the clutch member 40. On the other hand, when the hook portion 452 of the lock arm 45 is engaged with the protrusion portion 421 of the upper clutch gear 42, the play is ineffective in the clutch gear 40 so that the lower clutch gear 41 and the upper clutch gear 42 integrally rotate. It is possible to easily carry out switching of an open/close position of the lock arm 45 (e.g. between a position for locking to the protrusion portion 421 and a position for releasing a lock with respect to the protrusion portion 421) by moving the cam follower 451 of the lock arm 45 along the lock groove 43a of the lock cam arm 43.

That is, a combination of the protrusion portion 421 of the upper clutch gear 42, the lock arm 45, the lock arm cam 43 serves as a play controlling arrangement for controlling so that the play caused by the torsion spring (the play imparting arrangement) 44 is effective while the rotational angle of the lower clutch gear 41 lies in a first angular range and for controlling so that the play caused by torsion spring (the play imparting arrangement) 44 is ineffective to make the lower clutch gear 41 and the upper clutch gear 42 integrally move (rotate) while the rotational angle of the lower clutch gear 41 lies in a second angular range.

In addition, the lock arm cam 43 acts as a lock arm controlling arrangement for controlling so as to disengage the hook portion 452 of the lock arm 45 from the protrusion portion 421 of the upper clutch gear (the second clutch gear) 42 while the rotational angle of the lower clutch gear (the first clutch gear) 41 lies in the first angular range and so as to engage the hook portion 452 of the lock arm 45 with the protrusion portion 421 of the upper clutch gear (the second clutch gear) 42 while the lower clutch gear (the first clutch gear) 41 lies in the second angular range.

When the rotational angle of the lower clutch gear 41 lies in the above-mentioned second angular range, the lock is made with respect to the protrusion portion 421 by the lock arm 45 to make the play of the clutch member 40 ineffective. In addition, in the manner which will later be described, this lock is carried out for a duration where the load of the tape drive 10 becomes larger on seating/unseating of cartridge 20 such that the cam slider 14 moves the cartridge holder 15 in the vertical direction or the like.

On the other hand, when the rotational angle of the lower clutch gear 41 lies in the first angular range, the lock with respect to the protrusion portion 421 by the lock arm 45 is released to set (impart) the play in (to) the clutch member 40. In the manner which will later be described, this releasing of the lock is made in a case where the cartridge 20 lies near the cartridge insertion opening of the tape drive 10 so that the cam slider 14 moves the cartridge holder 15 in the horizontal direction (the insertion direction A).

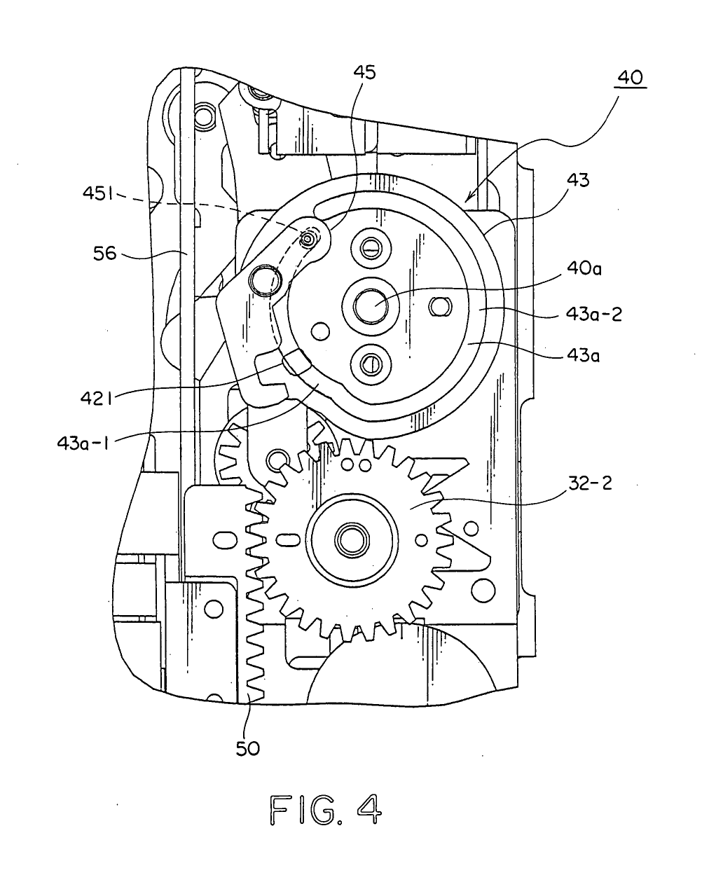

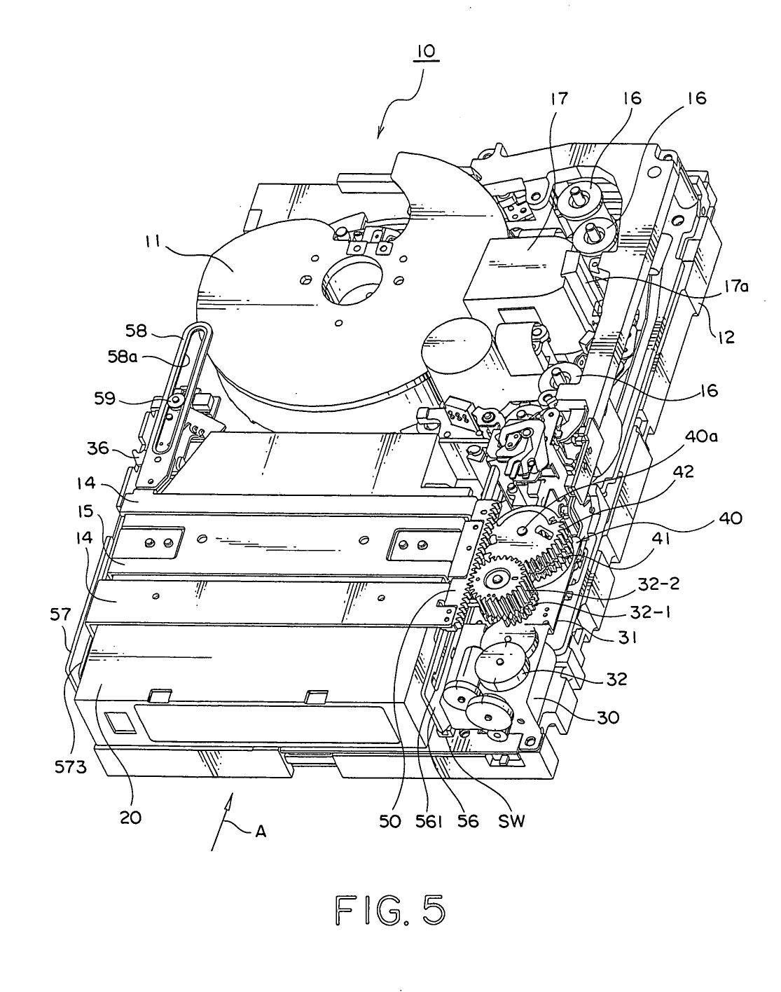

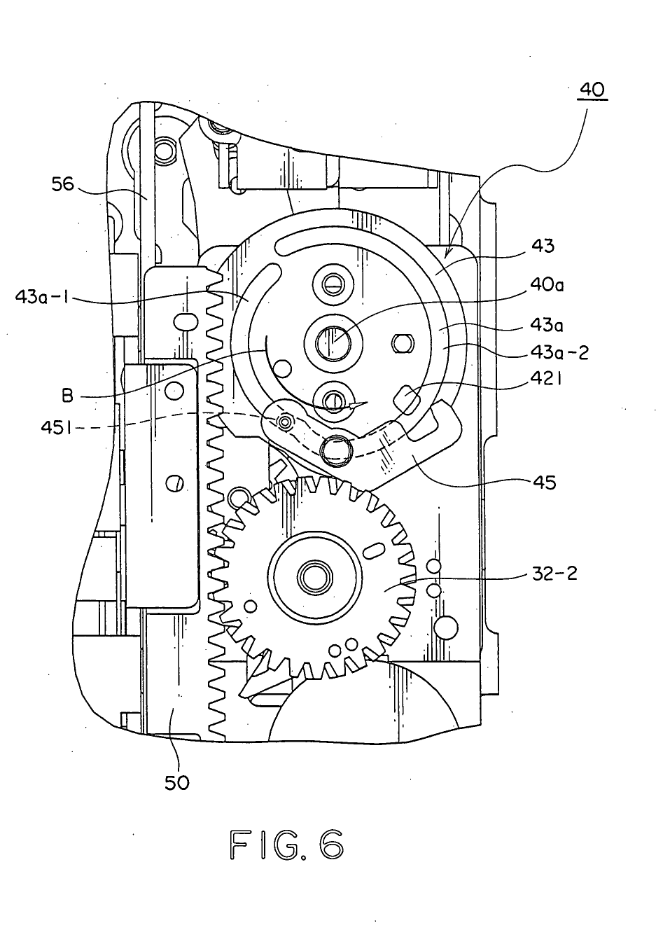

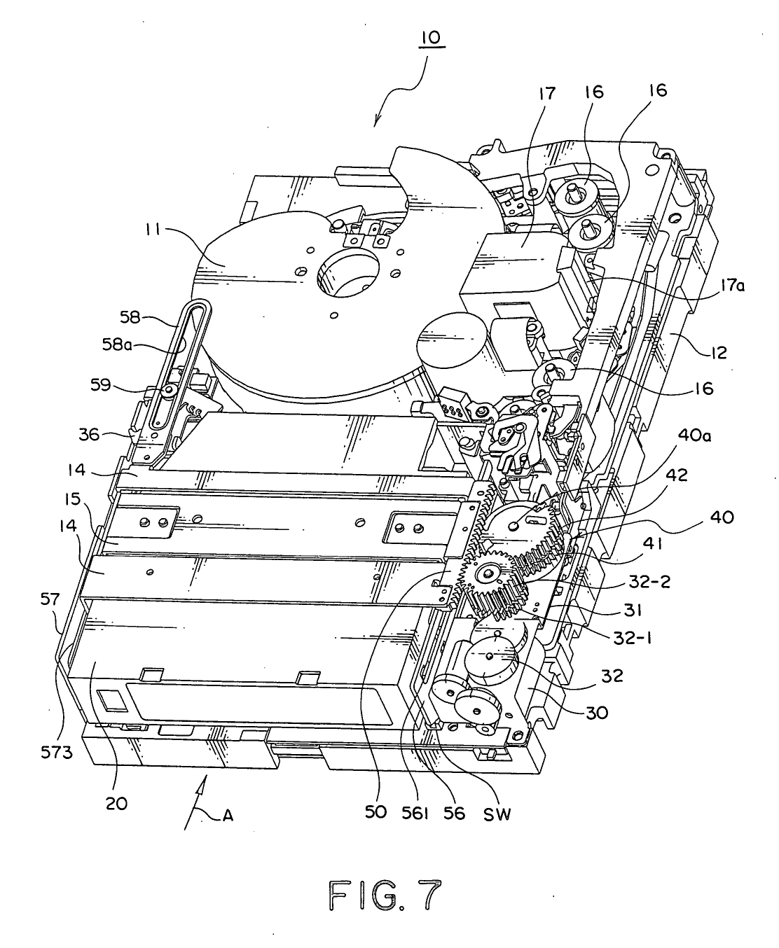

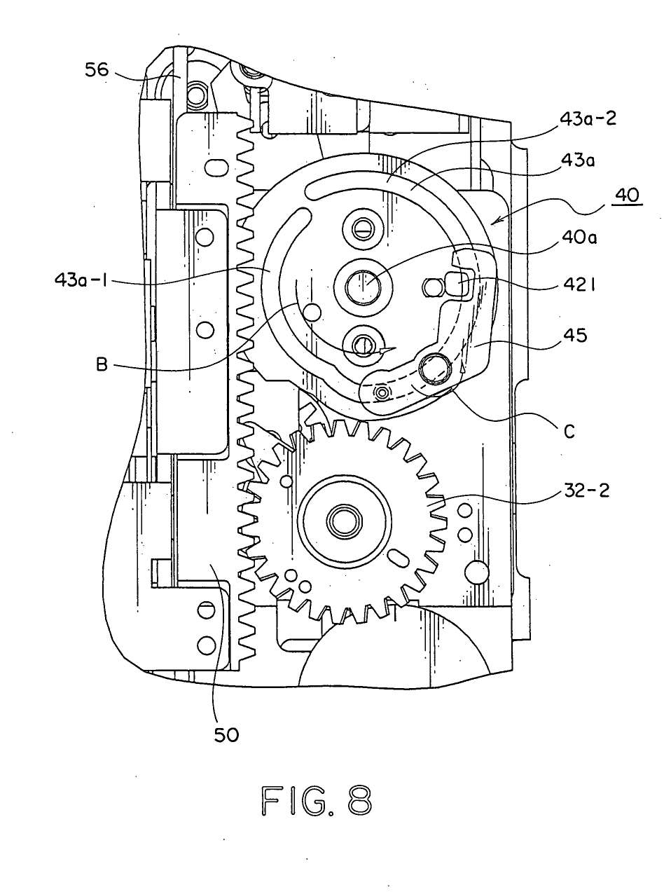

Referring now to FIGS. 4 through 8 in addition to FIGS. 1 to 3, the description will be made as regards operation of the clutch member 40. FIG. 4 is an enlarged plan view for use in describing a state of the clutch member 40 when the cartridge 20 lies near the cartridge insertion opening as the tape drive 10 illustrated in FIG. 1. FIG. 5 is a perspective view showing the tape drive 10 in a state where the cartridge 20 is inserted in the horizontal direction (the insertion direction) A as far as it. FIG. 6 is an enlarged plan view for use in describing anther state of the clutch member 40 when the tape drive 10 is put into the state illustrated in FIG. 5. FIG. 7 is a perspective view showing the tape drive 10 in a state where the cartridge 20 is moved in the vertical direction. FIG. 8 is an enlarged plan view for use in describing a still another state of the clutch member 40 when the tape drive 10 is put into the state illustrated in FIG. 7.

As shown in FIG. 4, the cam groove 43a formed in the lock arm cam 43 comprises a first cam groove portion 43a-1 formed on a first radius of curvature based on the rotation axis 40a and a second cam groove portion 43a-2 formed on a second radius of curvature on the rotation axis 40a. The second radius of curvature is longer than the first radius of curvature. When the cam follower 451 of the lock arm 45 is engaged with the first cam groove portion 43a-1 of the cam groove 43a, the rotational angle of the lower clutch gear 41 lies in the above-mentioned first angular range. On the other hand, when the cam follower 451 of the lock arm 45 is engaged with the second cam groove portion 43a-2 of the cam groove 43a, the rotational angle of the lower clutch gear 41 lies in the above-mentioned second angular range.

Referring first FIGS. 1 and 4, the description will proceed to the state of the clutch member 40 where the cartridge 40 lies near the cartridge insertion opening.

In this state, inasmuch as the rotational angle of the lower clutch gear 41 lies in the first angular range, the lock arm 45 is disengaged from the protrusion portion 421 projecting from the upper clutch gear 42, as shown in FIG. 4. Therefore, the clutch member 40 is put into a state where the play caused by the torsion spring 44 is set therein (imparted thereto). In this event, at the position illustrated in FIG. 4, the cam follower 451 of the lock arm 45 is engaged with the firs cam groove portion 43a-1 of the cam groove 43a formed in the lock arm cam 43.

Referring now to FIGS. 5 and 6, the description will proceed to the other state of the clutch member 40 when the cartridge 40 is inserted in the horizontal direction (the insertion direction) A as far as it.

Inasmuch as the first reduction gear 32-1 rotates around the rotation axis thereof in the clockwise direction by rotating the driving motor 30 in a predetermined direction, engaged with the first reduction gear 32-1, the lower clutch gear 41 rotates around the rotation axis 40a thereof in the counterclockwise direction as shown in an arrow B of FIG. 6. Thereby, rotatably mounted on the lower clutch gear 41, the lock arm 45 moves around the rotation axis 40a in the counterclockwise direction. Inasmuch as the rotational angle of the lower clutch gear 41 yet lies in the first angular range in this state, the lock arm 45 is yet disengaged from the protrusion portion 421 projecting from the upper clutch gear 42, as shown in FIG. 6. Therefore, the clutch member 40 is put into a state where the play caused by the torsion spring 44 is imparted thereto. Under the circumstances, at the position shown in FIG. 6, the cam follower 451 of the lock arm 45 is engaged with the first cam groove portion 43a-1 of the cam groove 43a formed in the lock arm cam 43.

Referring to FIGS. 7 and 8 lastly, the description will proceed to the still another state of the clutch member 40 when the cartridge 20 moves in the vertical direction.

By rotating the driving motor 30 in the predetermined direction in the manner which is described above, the lower clutch gear 41 rotates around the rotation axis 40a thereof in the counterclockwise direction, as shown in an arrow B of FIG. 8. Thereby, rotatably mounted on the lower clutch gear 41, the lock arm 45 moves around the rotation axis 40a in the counterclockwise direction. Therefore, as shown in FIG. 8, the cam follower 451 of the lock arm 45 is engaged with the second cam groove portion 43a-2 of the cam groove 43a formed in the lock arm cam 43 out of the first cam groove portion 43a-1. That is, the rotational angle of the lower clutch gear 45 changes from the first angular range to the second angular range. As a result, the lock arm 45 rotates around the lock arm pivot 46 in a counterclockwise direction, as shown in an arrow C of FIG. 8. Thereby, as shown in FIG. 8, the hook portion 452 of the lock arm 45 is engaged with the protrusion portion 421 projecting from the upper clutch gear 42. Accordingly, the clutch member 40 is put into the state where the play is ineffective so that the lower clutch gear 41 and the upper clutch gear 42 rotate integrally.

Therefore, inasmuch as the play of the clutch member 40 is ineffective at the duration (the position) where the load becomes larger on seating/unseating of the cartridge such that the cartridge 20 moves in the vertical direction or the like, the transmission mechanism operates with it integrated with the cam slider 14. Inasmuch as it is therefore possible to obviate discontinuity in operation of the tape drive 10, it is possible to improve reliability in the tape drive 10 without a shock or an impact to the transmission mechanism in a case where the load operation and the ejection operation are repeatedly carried out.

With the structure of the clutch member 40 as described above, it is possible to set (impart) the play in (to) the clutch member 40 at any rotational angle of the lower clutch gear (the first clutch gear) 41 and to be ineffective the play in the clutch member 40 to make the lower clutch gear (the first clutch gear) 41 and the upper clutch gear (the second clutch gear) 42 rotate integrally. In addition, it is possible to easily change the open/close position of the lock arm 45 (e.g. the position for locking to the protrusion portion 421 and the position for releasing the lock with respect to the protrusion portion 421) by changing a shape of the cam groove 43a formed in the lock arm cam 43.

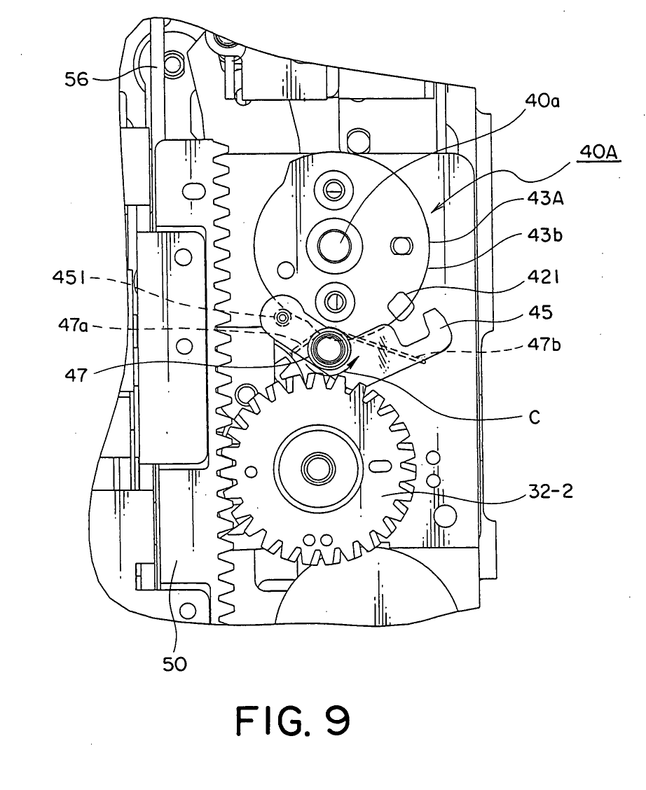

Referring to FIG. 9, the description will proceed to a clutch member 40A according to a second embodiment of this invention. The illustrated clutch member 40A is similar in structure and operation to the clutch member 40 illustrated in FIG. 2 except that the lock arm cam is modified in the manner which will later described and the clutch member 40A further comprises a second torsion spring 47 for making the lock arm 45 operate urging force. The lock arm cam is therefore depicted at a reference numeral of 43A. The same reference numerals are depicted at those having functions similar those illustrated in FIG. 2 and description thereof is omitted in order to simplify the description.

The lock arm cam 43A is similar in structure to the lock arm cam 43 illustrated in FIG. 2 except that the lock arm cam 43A comprises a cam surface 43b in lieu of the cam groove 43a. The cam surface 43b has a shape similar to an inner wall of the cam groove 43a of the lock arm cam 43. Accordingly, the lock arm cam 43A has a smaller size in comparison with the lock arm cam 43.

The second torsion spring 47 is mounted around the lock arm pivot 46. More specifically, the second torsion spring 47 has an end (one leg) which is fixed to the lower clutch gear 41. The second torsion spring 47 has another end (another leg) which is engaged with a protrusion (not shown) projecting from the lock arm 45. The second torsion spring 47 urges the cam follower 451 of the lock arm 45 so as to always press it against the cam surface 43b of the lock arm cam 43A and to make the lock arm 45 be slidably in contact with the cam surface 43b. With this structure, when the lower clutch gear 41 rotates, the lock arm 45 moves along the cam surface 43b of the lock arm cam 43A.

At any rate, the second torsion spring 47 serves as an urging arrangement for urging the cam follower 451 of the lock arm 45 to press it against the cam surface 43b of the lock arm cam 43A to make the lock arm 45 be slidably in contact with the cam surface 43b.

Accordingly, a combination of the lock arm cam 43A and the second torsion spring (the urging arrangement) 47 serves as a lock arm controlling arrangement for controlling so as to disengage the hook portion 452 of the lock arm 45 from the protrusion portion 421 of the upper clutch gear (the second clutch gear) 42 while the rotational angle of the lower clutch gear (the first clutch gear) 41 lies in the first angular range ant so as to engage the hook portion 452 of the lock arm 45 with the protrusion portion 421 of the upper clutch gear (the second clutch gear) 42 while the rotational angle of the lower clutch gear (the first clutch gear) 41 lies in the second angular range.

Accordingly, similar to the clutch member 40, in the clutch member 40A having structure which is described above, when the lower clutch gear 41 rotates, the lock arm 45 moves along the cam surface 43b of the lock arm cam 43A and at the predetermined rotational position of the lower clutch gear 41, the hook portion 452 of the lock arm 45 is engaged with or disengaged from the protrusion portion 421 of the upper clutch gear 42.

While this invention has thus far been described in conjunction with a few preferred embodiments thereof, it is to be understood that modifications will be apparent to those skilled in the art without departing from the spirit of the invention. For example, although only an example in a case of applying the clutch member to the recording and/or reproducing device is described in the above-mentioned embodiments, the cutch member may be applicable to other devices other than the recording and/or reproducing device. In addition, although the torsion spring is exemplified as the play imparting arrangement for imparting the play to the clutch member, others rather than the torsion spring may be used as the play imparting arrangement. Furthermore, the play controlling arrangement and the lock arm controlling arrangement are not limited to those of the above-mentioned embodiments, those having other structures may be adopted.

What is claimed is:

1. A recording and/or reproducing device comprising a cartridge holder for holding a cartridge, a cam slider for moving said cartridge in a horizontal direction and a vertical direction, a driving motor, a transmission mechanism, disposed between said driving motor and a cam slider, for transmitting driving force of said driving motor to said cam slider, wherein said transmission mechanism includes a clutch member where a play is effective in a first angular range and the play is ineffective in a second angular range.

2. The recording and/or reproducing device as claimed in claim 1, wherein said first angular range corresponds to a range where said cam slider makes said cartridge holder move in the horizontal direction, said second angular range corresponds to another range where said cam slider makes said cartridge holder move in the vertical direction.

3. The recording and/or reproducing device as claimed in claim 1, wherein said transmission mechanism includes a first reduction gear for transmitting the driving force of said driving motor to said clutch member and a second reduction gear for transmitting transmission force of said clutch member to said cam slider, wherein said clutch member couples said first reduction gear with said second reduction gear with the play.

4. The recording and/or reproducing device as claimed in claim 3, wherein said clutch member comprises:
a rotation axis;
a first clutch member, rotatably disposed around said rotation axis, for being engaged with said first reduction gear;
a second clutch member, rotatably disposed around said rotation axis, for being engaged with said second reduction gear;
a play imparting arrangement, disposed between said first clutch member and said second clutch member, for imparting the play to said clutch member; and
a play controlling arrangement for controlling so that the play caused by said play imparting arrangement is effective while a rotational angle of said first clutch gear lies in the first angular range and for controlling so that the play caused by said play imparting arrangement is ineffective so as to make said first clutch gear and said second clutch gear move integrally while the rotational angle of said first clutch gear lies in the second angular range.

5. The recording and/or reproducing device as claimed in claim 4, wherein said play imparting arrangement comprises a torsion spring.

6. The recording and/or reproducing device as claimed in claim 4, wherein said play controlling arrangement comprises:
a protrusion portion for projecting from said second clutch gear toward said first clutch gear;
a lock arm, rotatably mounted on said first clutch gear around a pivot thereof, having a hook portion enable to engage with said protrusion portion; and
a lock arm controlling arrangement for controlling so as to disengage the hook portion of said lock arm from said protrusion portion while the rotational angle of said first clutch gear lies in the first angular range and for controlling so as to engage the hook portion of said lock arm with said protrusion portion while the rotational angle of said first clutch gear lies in the second angular range.

7. The recording and/or reproducing device as claimed in claim 6, wherein said lock arm comprises a cam follower at an end opposite to said hook portion, said cam follower being freely inserted through an opening of said first clutch gear,
wherein said lock arm controlling arrangement comprises a lock arm cam, fixed to a fixing member, having a cam groove with which said cam follower is engaged.

8. The recording and/or reproducing device as claimed in claim 6, wherein said lock arm comprises a cam follower at an end opposite to said hook portion, said cam follower being freely inserted through in an opening of said first clutch gear,
wherein said lock arm controlling arrangement comprises:
a lock arm cam, fixed to a fixing member, having a cam surface; and
an urging arrangement for urging said cam follower to press said cam follower against said cam surface so as to make said lock arm be slidably in contact with said cam surface.

9. The recording and/or reproducing device as claimed in claim 8, wherein said urging arrangement comprises a torsion spring mounted around said pivot.

10. A clutch member for coupling a first gear with a second gear with a play, wherein said clutch member comprises:
a rotation axis;
a first clutch member, rotatably disposed around said rotation axis, for being engaged with said first gear;
a second clutch member, rotatably disposed around said rotation axis, for being engaged with said second gear;
a play imparting arrangement, disposed between said first clutch member and said second clutch member, for imparting the play to said clutch member; and
a play controlling arrangement for controlling so that the play caused by said play imparting arrangement is effective while a rotational angle of said first clutch gear lies in a first angular range and for controlling so that the play caused by said play imparting arrangement is ineffective so as to make said first clutch gear and said second clutch gear move integrally while the rotational angle of said first clutch gear lies in a second angular range.

11. The clutch member as claimed in claim 10, wherein said play imparting arrangement comprises a torsion spring.

12. The clutch member as claimed in claim 10, wherein said play controlling arrangement comprises:
a protrusion portion for projecting from said second clutch gear toward said first clutch gear;
a lock arm, rotatably mounted on said first clutch gear around a pivot thereof, having a hook portion enable to engage with said projection portion; and
a lock arm controlling arrangement for controlling so as to disengage the hook portion of said lock arm from said protrusion portion while the rotational angle of said first clutch gear lies in the first angular range and for controlling so as to engage the hook portion of said lock arm with said protrusion portion while the rotational angle of said first clutch gear lies in the second angular range.

13. The clutch member as claimed in claim 12, wherein said lock arm comprises a cam follower at an end opposite to said hook portion, said cam follower being freely inserted through an opening of said first clutch gear,
wherein said lock arm controlling arrangement comprises a lock arm cam, fixed to a fixing member, having a cam groove with which said cam follower is engaged.

14. The clutch member as claimed in claim 12, wherein said lock arm comprises a cam follower at an end opposite to said hook portion, said cam follower being freely inserted through an opening of said first clutch gear,
wherein said lock arm controlling arrangement comprises:
a lock arm cam, fixed to a fixing member, having a cam surface; and
an urging arrangement for urging said cam follower to press said cam follower against said cam face so as to make said lock arm be slidably in contact with said cam surface.

15. The clutch member as claimed in claim 14, wherein said urging arrangement comprises a torsion spring mounted around said pivot.
